(19) United States
(12) Patent Application Publication
(10) Pub. No.: US 2013/0066709 A1
(43) Pub. Date: Mar. 14, 2013

(54) METHOD OF AND SYSTEM FOR DETERMINING CONTEXTUALLY RELEVANT ADVERTISEMENTS TO BE PROVIDED TO A WEB PAGE

(71) Applicant: Sean Grant Riley, Gardens (ZA)

(72) Inventor: Sean Grant Riley, Gardens (ZA)

(73) Assignee: AD DYNAMO INTERNATIONAL (PTY) LTD., Greenpoint (ZA)

(21) Appl. No.: 13/699,612

(22) PCT Filed: Jun. 4, 2011
(86) PCT No.: PCT/IB11/01217

§ 371 Date: Nov. 21, 2012

Related U.S. Application Data
(60) Provisional application No. 61/351,339, filed on Jun. 4, 2010.

(51) Int. Cl. G06Q 30/02

(52) U.S. Cl. 705/14.42; 705/14.41

(57) ABSTRACT

The invention relates to a method, and associated system, of determining contextually relevant advertisements to serve to a web page, the method comprising steps of providing a content database of content associated with web pages; storing keywords having bids associated therewith, the keywords being associated with advertisements; storing a plurality of advertisements associated with different keywords and/or advertisement-keyword combinations; analysing a web page and extracting prominent terms therefrom; comparing each extracted prominent term with keywords stored in the keyword database and/or advertisement-keyword combinations to determine and store a relevance score for each identified keyword; searching all content stored in the content database for each identified keyword having active bids, assigning and storing further relevance scores to identified keyword respectively in terms of a relevance to the content stored in the content database; and using the stored relevance scores for the identified keywords to select advertisements to serve the web page.

### BACKGROUND OF THE INVENTION

THIS invention relates to a method of and system for determining contextually relevant advertisements to be provided to a web page.

Advertisers of goods and/or services have recognized the wide and expanding reach of the Internet, particularly the World Wide Web or “web”, as an effective and measurable medium for disseminating advertisements to the public. In this regard, it has become commonplace for advertisers to provide advertisements, typically in the form of visual and/or audiovisual displays, to website publishers for placement at a visible location on web pages of their respective websites. In this way, website publishers or owners may earn revenue as advertisers typically have to pay a particular website publisher to advertise on their website. In most cases, website publishers receive revenue from particular advertisers in accordance with click-through rates, or the like, associated with the advertiser's advertisements. In this way, website publishers therefore receive revenue based on a measure of success of an advertiser's online advertising campaign.

In the online advertising space, it is desirable that web pages displaying advertisements be substantially matched to the advertisements displayed thereby. In other words, it is desirable that advertisements displayed on a particular website be contextually relevant thereto. For example, if a web page has content about music, it is desirable to have advertisements related to music such as advertisements for an MP3 site, or the like. This in turn benefits both the advertiser, as they would be reaching a target market more accurately; and the website publisher, as they stand a better chance of maximizing their revenue from advertisers by providing advertisements which have a greater probability of being clicked on by their readers.

An online advertiser, for example, of an MP3 website, could contact a website publisher, for example, of music related content, to place their contextually relevant advertisements on at least one of the website publisher's web pages.

However, it would be a tedious process for all online advertisers to take this approach. In this regard, it will be appreciated that it is difficult to provide at least a system for providing contextually relevant advertisements to websites which can handle large volumes of website publishers and advertisements, be scaled to growth needs accordingly, and also be highly resilient.

In this regard, it is an object of the present invention to at least provide contextually relevant advertisements to web pages or websites. It is also an object of the present invention to at least address the need for providing an online advertising method and/or system which maximizes performance of online advertisement campaigns, handles large volumes of website publishers, online advertisers and hence advertisements, can be scaled to growth needs, and be highly resilient.

### SUMMARY OF THE INVENTION

According to a first aspect of the invention, there is provided a method for determining at least one contextually relevant advertisement to be provided to a web page, the method comprising:
storing a plurality of keywords having bids associated therewith in a keyword database;
storing a plurality of advertisements having bids associated with different keywords in an advertisement database;
analyzing content of a target document and extracting prominent terms therefrom, wherein the target document is associated with content of a particular web page referenced by a particular URL;
comparing the extracted prominent terms with the keywords associated with various advertisements or advertisement-plus-keyword combinations stored in the advertisement database thereby to obtain and store, in a scoring database, a relevance score for each extracted prominent term or keyword associated with the target document;
searching all documents stored in the content database, for each keyword on which there are active bids, and assigning and storing a further relevance score to each keyword, in the scoring database, in terms of a relevance to a predetermined number of relevant documents located in the content database; and
using at least the stored relevance scores to select at least one contextually matched advertisement from the advertisement database for serving or sending to the browsed web page.

The method may comprise using at least the stored relevance scores to generate an advertisement queue of contextually matched advertisements in order of priority for serving or sending to the browsed web page.

The method may comprise using information indicative of historic performance of the advertisement-plus-keyword combination to generate the advertisement queue, wherein the performance comprises the historic click through rate of the advertisement-plus-keyword combination.

The method may comprise generating the advertisement queue by using one or more of a value bid by an advertiser for a click and an extrapolated bid per click derived from a cost per mille (CPM).

The method may comprise:
determining if a format of a contextually relevant advertisement to be served matches a channel format, or the channel size, of the browsed web page to which the advertisement is to be served; and
serving or sending to the browsed web site only those contextually relevant advertisements which substantially match a channel format size of the browsed web page.

The method may comprise the step of receiving the target document to be analysed.

The method may comprise the step of receiving the target document to be analysed by way of a channel setup module disposed in the web page.

The method may comprise serving or sending the at least one contextually matched advertisement to the web page.

The prominent terms may be the most frequently occurring terms in the target document.

For each term that has a relevance score to a URL, the method may comprise retrieving all advertisements with active bids on the term in question.

It will be noted that the score of a term from a particular document may be affected by the frequency of the term within the document and also with the frequency of the term in an entire collection of documents in the content database.

According to a second aspect of the invention, there is provided a system for determining at least one contextually relevant advertisement to be provided to a web page, the system comprising:
a keyword database configured to store at least a plurality of keywords having bids associated therewith;
an advertisement database configured to store at least a plurality of advertisements having bids associated with different keywords;
a forward matching module configured to:
   analyze content of a target document and extracting prominent terms therefrom, wherein the target document is associated with content of a particular web page referenced by a particular URL;
   compare the extracted prominent terms with the keywords associated with various advertisements or advertisement-plus-keyword combinations stored in the advertisement database thereby to obtain and store, in a scoring database, a relevance score for each extracted prominent term or keyword associated with the target document; and
   a reverse matching module configured to search all documents stored in the content database, for each keyword on which there are active bids, and assign and store a further relevance score to each keyword, in the scoring database, in terms of a relevance to a predetermined number of relevant documents located in the content database;
   wherein the system is configured to use at least the stored relevance scores to select at least one contextually matched advertisement from the advertisement database for serving or sending to the browsed web page.

The system may be configured to use at least the stored relevance scores to generate an advertisement queue of contextually matched advertisements in order of priority for serving or sending to the browsed web page.

The system may be configured to use information indicative of historic performance of the advertisement-plus-keyword combination to generate the advertisement queue, wherein the performance comprises the historic click through rate of the advertisement-plus-keyword combination.

The system may be configured to generate the advertisement queue by using one or more of a value bid by an advertiser for a click and an extrapolated bid per click derived from a cost per mille (CPM).

The system may comprise:
means for determining if a format of a contextually relevant advertisement to be served matches a channel format, or the channel size, of the browsed web page to which the advertisement is to be served; and
means for serving or sending to the browsed web site only those contextually relevant advertisements which substantially match a channel format size of the browsed web page.

The forward matching module may be configured to receive the target document to be analysed by way of a content receiving module communicatively coupled to a channel setup module disposed in the web page.

The system may comprise means to serve or send the at least one contextually matched advertisement to the web page.

The prominent terms may be the most frequently occurring terms in the target document.

The system may be included in an advertising server.

According to a third aspect of the invention, there is provided a method of determining at least one contextually relevant advertisement to be provided to a web page, the method comprising:
providing a content database storing content, or information indicative thereof, associated with a plurality of web pages;
storing a plurality of keywords having bids associated therewith in a keyword database, wherein the keywords are associated with one or more advertisements;
storing a plurality of advertisements associated with different keywords and/or advertisement-keyword combinations in an advertisement database;
analysing a web page and extracting prominent terms therefrom;
comparing each extracted prominent term with one or more of the keywords associated with various advertisements stored in the keyword database and/or advertisement-keyword combinations stored in the advertisement database thereby to determine and store, in a scoring database, a relevance score for each identified keyword substantially relevant to the extracted prominent term;
searching all content stored in the content database for each identified keyword on which there are active bids, and assigning and storing a further relevance score to each identified keyword, in the scoring database, in terms of a relevance to the content stored in the content database; and
using at least the stored relevance scores for the identified keywords to select at least one advertisement from the advertising database to serve or send to the web page.

The method may comprise analysing a target document and extracting prominent terms therefrom, wherein the target document comprises content, or information indicative thereof, associated with the web page.

The method may comprise the step of receiving the web page or target document to be analysed.

The method may comprise the step of receiving the web page or target document to be analysed by way of a channel setup module disposed in the web page.

The method may comprise searching all documents stored in the content database, for each identified keyword on which there are active bids, and assigning and storing a further relevance score to each keyword, in the scoring database, in terms of relevance to a predetermined number of relevant documents located in the content database, wherein each document in the content database comprises content, or information indicative thereof, from a web page.

The method may comprise serving or sending the determined advertisement to the web page.

The prominent terms may be the most frequently occurring terms in the web page content. This may be determined by merely counting the number of commonly occurring terms in the web page.

The method may comprise using at least the relevance scores of the identified keywords to generate an advertisement queue of contextually matched advertisements to serve or send to the web page.

The plurality of advertisements may have bids associated therewith.

For each identified keyword, the method may comprise retrieving all advertisements with active bids on the identified keyword from the advertising database.

The method may comprise generating the advertisement queue by using one or more of a value bid by an advertiser for a click, an extrapolated bid per click derived from a cost per mille (CPM), and historic performance of the advertisement-keyword combination, wherein the historic performance comprises a historic click through rate of the advertisement-keyword combination.

According to a fourth aspect of the invention, there is provided a system for determining at least one contextually relevant advertisement to be provided to a web page, the system comprising:
a content database storing content, or information indicative thereof, associated with a plurality of web pages;
a keyword database storing a plurality of keywords having bids associated therewith, wherein the keywords are associated with one or more advertisements;
an advertisement database storing a plurality of advertisements associated with different keywords and/or advertisement-keyword combinations;
a forward matching module comprising:
   means to analyse a web page and extracting prominent terms therefrom; and
   means to compare each extracted prominent term with one or more of the keywords associated with various advertisements stored in the keyword database and/or advertisement-keyword combinations stored in the advertisement database thereby to determine and store, in a scoring database, a relevance score for each identified keyword substantially relevant to the extracted prominent term;
a reverse matching module comprising:
   means to search all content stored in the content database for each identified keyword on which there are active bids, and
   assign and store a further relevance score to each identified keyword, in the scoring database, in terms of a relevance to the content stored in the content database; and
   means to use at least the stored relevance scores for the identified keywords to select at least one advertisement from the advertising database to serve or send to the web page.

The forward matching module may comprise means to analyse a target document and extract prominent terms therefrom, wherein the target document comprises content, or information indicative thereof, associated with the web page.

The forward matching module may be configured to receive the web page or target document to be analysed by way of a content receiving module communicatively coupled to a channel setup module disposed in the web page.

The reverse matching module may comprise means to search all documents stored in the content database, for each identified keyword on which there are active bids; and means to assign and store a further relevance score to each keyword, in the scoring database, in terms of relevance to a predetermined number of relevant documents located in the content database, wherein each document in the content database comprises content, or information indicative thereof, from a web page.

The system may comprise means to serve or send the determined advertisement to the web page.

The most prominent terms may be the most frequently occurring terms in the web page content.

The system may comprise means to use at least the relevance scores of the identified keywords to generate an advertisement queue of contextually matched advertisements to serve or send to the web page.

The plurality of advertisements may have bids associated therewith.

The system may comprise means to generate the advertisement queue by using one or more of a value bid by an advertiser for a click, an extrapolated bid per click derived from a cost per mille (CPM), and historic performance of the advertisement-keyword combination, wherein the historic performance comprises a historic click through rate of the advertisement-keyword combination.

The system may advantageously be included in an advertising server.

### BRIEF DESCRIPTION OF THE DRAWINGS

FIG. 1 shows a schematic diagram of a network embodying an advertising system in accordance with an example embodiment of the invention;

FIG. 2 shows a schematic diagram of the advertising system of FIG. 1 in greater detail;

FIG. 3 shows a schematic diagram of an advertising server of FIG. 2 in greater detail;

FIG. 4 shows a flow diagram of a method for operating an online advertising system in accordance with an example embodiment of the invention;

FIG. 5 shows a flow diagram of a method for determining at least one contextually relevant advertisement to be provided to a web page;

FIG. 6 shows a conceptual diagram illustrating a step of determining at least one contextually relevant advertisement to be provided to a web page;

FIG. 7 shows a conceptual diagram illustrating another step of determining at least one contextually relevant advertisement to be provided to a web page;

FIG. 8 shows a conceptual diagram illustrating yet another step of determining at least one contextually relevant advertisement to be provided to a web page;

FIG. 9 shows a flow diagram of additional method steps for either the methods embodied in the flow diagrams of FIG. 4 or FIG. 5;

FIG. 10 shows a flow diagram of additional method steps for either the methods embodied in the flow diagrams of FIG. 4 or FIG. 5;

FIG. 11 shows a flow diagram of additional method steps for the method embodied in the flow diagram of FIG. 4;

FIG. 12 shows schematic drawing of a system for determining contextually relevant advertisements to be provided to a web page in accordance with an example embodiment; and

FIG. 13 shows a diagrammatic representation of a machine in the example form of a computer system in which a set of instructions for causing the machine to perform any one or more of the methodologies discussed herein, may be executed.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

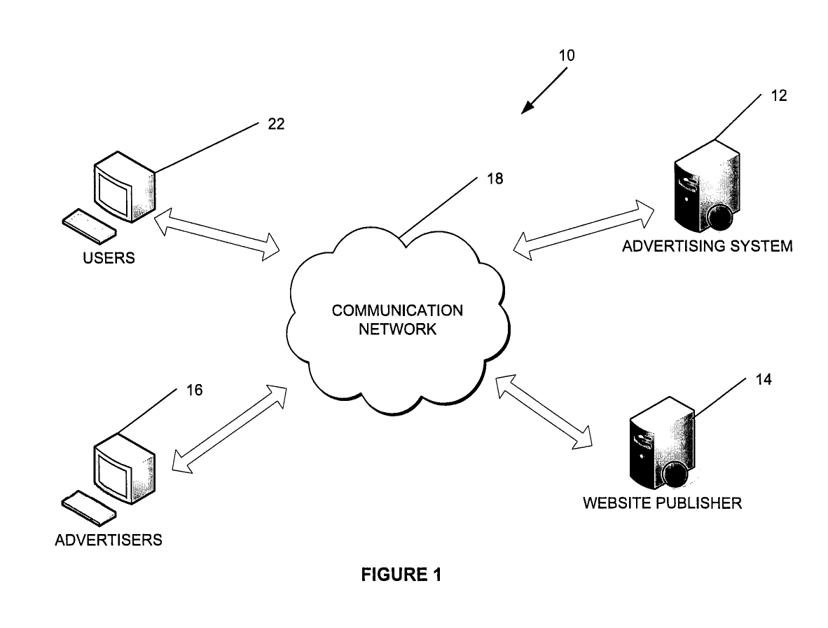

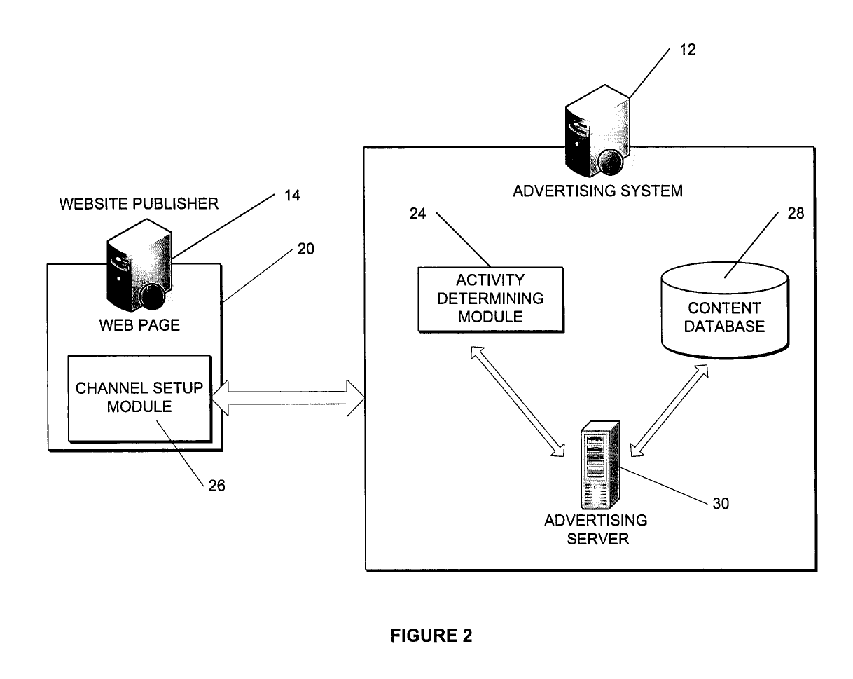

Referring to FIGS. 1 and 2 of the drawings of the drawings where a network in accordance with an example embodiment is generally indicated by reference numeral 10. The network 10 advantageously comprises an adverting system, particularly an online advertising system 12 for facilitating at least providing contextually relevant advertisements (ads) to websites or web pages published by at least website publishers 14.

“Website” and “web page” are used interchangeably in the specification. However, it will be noted that a website may comprise a plurality of web pages.

The advertising system 12 is arranged to communicate with a website publisher or website owner 14 and an advertiser 16 over a communication network 18. The system 12 may advantageously communicate with a plurality of advertisers and website publishers. However, for ease of illustration, only one of each is shown.

The website publisher 14 publishes a website comprising at least web page 20 (FIG. 2) having content which is accessed by users, web surfers, blog readers, or the like 22 over the communication network 18 by way of a suitable computing device, for example, a computer connected to the network 18, or the like. The content on web pages 20 is typically in the form of visual data, for example, pictures, text, diagrams, graphics, or the like; audio data, for example music, speech, or the like; and/or audiovisual data, for example, movies, videos, or the like.

The communication network 18 may be a packet-switched network and may form part of the Internet. Instead, the communications network 18 may be a circuit switched network, public switched data network, or the like.

In some example embodiments, the network 18 may advantageously be a mobile data network, for example, GPRS (Global Packet Radio Service), or even a mobile telecommunication network. In these example embodiments, the website publishers 14 may be mobile website publishers and the web pages 20 may be mobile web pages accessible by users 22 via a mobile communication device.

In any event, because of the reach of these web pages 20, advertisers 16 find it desirable to have their advertisements provided on the web pages 20 in order to advertise for their goods and/or services, in exchange for a monetary value. However, in order to increase the chances of their advertisements being shown to a desired target audience, advertisers often prefer to have their adverts shown on websites or web pages 20 which are contextually relevant to their goods and/or services being advertised. Also, website publishers 14 prefer to have advertisements on their websites which have an increased likelihood of being of interest to their users or readers 22 as they receive increased revenue depending on the click-through-rates (impressions) associated with advertisements displayed on their web pages 20. In this regard, the present online advertising system 12 seeks at least to address the issue of providing contextually relevant advertisements to websites.

To this end, the advertising system 12 comprises a plurality of components or modules which correspond to the functional tasks to be performed by the advertising system 12. In this regard, “module”, or even “means”, in the context of the specification will be understood to include an identifiable portion of code, computational or executable instructions, data, or computational object to achieve a particular function, operation, processing, or procedure. It follows that a module or means need not be implemented in software; a module may be implemented in software, hardware, or a combination of software and hardware. Further, the modules or means need not necessarily be consolidated into one device but may be spread across a plurality of devices in the network 10 or communication network 18 such that the advertising system 12 may be operable to use the functionality provided by a module or means from within the network 10 or communication network 18.

Although, the system 12 and the modules thereof, will be described with reference to the function they perform, it will be noted that in certain cases, the system 12 and the modules could perform the operations to achieve the desired end by themselves or by way of one or more means.

In particular, the advertising system 12 comprises an activity determining module 24 communicatively coupled to a channel setup module 26 provided at a website or web page 20 (FIG. 2). The activity determining module 24 is configured to determine, by way of the channel setup module 26, every time a website or web page 20 comprising the channel setup module 26 is browsed. In other words, the activity determining module 24 is configured to determine, by way of the channel setup module 26, browsing activity on the web page 20.

It will be noted that the channel setup module 26 may be a set of computer executable instructions or software code stored and run from a web page 20. The module 26 may therefore be a software program, object, agent, or the like operable to run from a web page 20, particularly from a web server associate with the website publisher 14. In this regard, the module 26 advantageously allows the advertising system 12 conveniently to communicate and interact with respective web pages 20 which have the channel setup modules 26. The channel setup module 26, although operated from a web page 20 typically remote from the system 12, may therefore be deemed to be part of the system 12 (more detail of the channel setup module 26 and its operation will follow below).

The system 12 further comprises a content database 28 configured at least to store content from web pages 20 comprising the channel setup module 26. The content stored may be as hereinbefore described and, for ease of reference, the content for each particular web page may be referenced by way of a unique uniform resource locator (URL) associated therewith. The content may be stored in the database and indexed, for example, in a Lucene Index. In this regard, it will be understood that “document” in the context of this specification may be understood to mean content from a particular web page 20. It follows that the content database 28 stores a plurality of documents.

Instead of content from a plurality of web pages, it will be appreciated that the content database 28 is configured to store content from at least one web page 20.

The advertising system 12 advantageously comprises an advertising server 30 communicatively coupled to both the activity determining module 24 and the content database 28 such that each time a website or web page 20 comprising the channel setup module 26 is browsed, the advertising server 30 is alerted thereto and is operated to determine if a substantial amount recent content or information from the browsed web page 20 is stored in a content database 28 wherein if a substantial amount of the content from the browsed web page 20 stored in the content database 28 is out of date and/or the browsed web page 20 or a substantial amount of the content associated with the browsed web page 20 is new, the advertising server 30 is configured to receive or retrieve content from the browsed web page 30 and store the received content in the content database 28. In this case, the advertising server 30 is configured to serve or send at least one best fit advertisement to the browsed web page 20. Best fit advertisements are any advertisements served to the same website publisher 14 historically. They may not have any relevance to the current URL but as soon as an advertisement queue (described below) is generated, more relevant advertisements will be served.

If a substantial amount of the content from the browsed web page 20 stored in the content database 28 is not out of date, the advertising server 30 is configured to serve or send at least one selected advertisement to the browsed web page 20, the selected advertisement being contextually relevant to the content of the web page 20.

It will be noted that in some example embodiments, the modules 24 and 28 are provided in the advertising server 30 such that the system 12 (sans the channel setup module 26) effectively is provided within the advertising server 30. The advertising server 30 may in turn be an application server residing in or connectable to the communication network 18. However, for ease of explanation, the system 12 will be described with the advertising server 30 as a separate integer thereof. It will be appreciated by those skilled in the art that these variations of explanation should not detract from invention as disclosed herein.

In any event, the advertising server 30 also comprises a plurality of components and modules which perform the functional tasks of the advertising server 30. In this regard, the discussion above regarding the components and modules of the system 12 may be extended to the components and modules of the server 30. The modules of the server 30 need not reside in the server 30, or even in the system 12, but may reside in the network 10 or 12 to provide functionality therefrom.

In particular, the advertising server 30 comprises a content receiving module 32 configured to receive recent content from the browsed web page 20, as well as a content comparator module 34 configured to compare the received recent content from the browsed web page 20 with content stored in the content database corresponding to that particular web page 20 so as at least to determine if substantially recent content of the browsed web page 20 is available or stored in the content database 28 or if the received content or URL (uniform resource locator) is substantially new. It will be appreciated that if the recent content from the web page is substantially stored in the content database then the content stored in the content database may be substantially up to date. Similarly, if the recent content from the web page is not substantially stored in the content database then the content stored in the content database may be substantially out of date or may be new, for example, from a new web page.

When receiving the content from the browsed web page 20, the module 32 may be arranged to optionally store the same in the content database for the module 34 to determine if the content is recent or not. Receiving the content also comprises receiving the unique URL. It follows that if the module 34 can't find the content or the URL of the browsed web page 20 in the database 28, then the web page 20 being browsed is new.

In a preferred example embodiment, the content comparator module 34 merely determines if content from a particular web page stored in the content database 28 has been received within a predetermined time period or threshold such that if the content from the web page has been received within the predetermined time period or threshold then the content is deemed to be recent and if the content has been received outside the predetermined time period or threshold then the content is deemed to be out of date. For example, if the module 34 determines that content from the website stored in the database 28 is older than, for example, 24 hours then the content is not recent and vice versa. In this example embodiment, it is important for any data stored in the content database 28 be assigned a time stamp.

As mentioned above, a particular web page 20, or content associated therewith, may be identified, for example, in the content database 28 by way of the (URL) associated therewith.

The server 30 also advantageously comprises an advertisement database 36 for storing a plurality of advertisements from the plurality of advertisers 16. In this regard, the advertisement database 36 may be configured to receive advertisements and bids for keywords from advertisers, and store these advertisements with bids. For example, advertisements for music websites would have bids for keywords associated with music such as a particular artist's name, keywords describing a particular style of music, for example, jazz, hip hop, or the like.

The advertising server 30 also conveniently comprises an advertisement selection module 38 configured to select at least one contextually relevant advertisement from advertisement database 36 for serving or sending to the browsed web page 20.

It will be appreciated that the serving of the contextually relevant advertisement is facilitated by the channel setup module 26, which will be discussed below.

The advertisement selection module 38 is conveniently configured to store a plurality of keywords having bids associated therewith in a keyword database 40; and also store a plurality of advertisements having bids associated with different keywords in the advertisement database 36.

The advertisement selection module 38 also preferably comprises a forward matching module 42 configured to analyse content of a target document and extract prominent terms therefrom. The module 38 could potentially achieve this end by simply providing the most commonly occurring terms in the document, determined, for example, by way of a simple count, as the prominent terms. The target document is associated with content of a particular web page 20 referenced by a particular URL. The module 42 is further arranged to compare the extracted prominent terms with the keywords associated with various advertisements or advertisement-plus-keyword combinations stored in the advertisement database 36 thereby to obtain and store, in a scoring database 44, a relevance score for each identified keyword associated with the target document or prominent term. It will be appreciated that the module 42 may be configured to determine or calculate this relevant score.

The advertising selection module 38 also advantageously comprises a reverse matching module 46 configured to search all documents stored in the content database 28, for each identified keyword on which there are active bids, and assign and store a further relevance score to each keyword, in the scoring database 44, in terms of a relevance to a predetermined number of relevant documents located in the content database 28. It will be appreciated that the module 38 may be configured to determine or calculate this relevant score.

These relevance scores obtained relates to a term/keyword and a document. In other words, the relevance score is a score which a keyword or term has for all documents in the content database 28 as well as for a specific document.

It will be further noted that both forward and reverse matching are processes that run all the time, or in other words continuously, and not specifically on request for an advertisement.

As alluded to above, the advertisement selection module 38, and its modules 42 and 44, may not be situated solely within the server 30 and may also be provided within the network 10 or 18 to provide functionality to the system 12 as described herein. In the same way, it will be understood that the databases 28, 36, 40, and 44 may conveniently be spread across the network 10 or 12. Instead, or in addition, the databases 28, 36, 40, and 44 may be a single database or memory storing respective information. However, for ease of explanation reference will be made to each database separately.

Also, it will be appreciated that the system comprising at least the modules 42, 46, databases 44, 36, and 40 may be a separate system for determining at least one contextually relevant advertisement to be provided to a web page 20 as will be discussed below.

In any event, the advertisement selection module 38 may be configured to use at least the stored relevance scores to generate an advertisement queue of contextually matched advertisements in order of priority for serving or sending to the browsed web page. Advertisement queues are maintained for each URL and location combination. A location may be a country, region, or city. Advertisement queues are only maintained for URLs and locations with recent activity. For example, if a URL that is browsed predominantly by South African users is suddenly browsed by a user in Brazil the system 12 is configured to immediately generate a relevant advertisement queue for the Brazil-URL combination.

It must be mentioned that the advertisement queue, for a particular URL, is an ordered list of advertisements that will be used for serving advertisements to that URL. Other factors are still taken into account when selecting ads from the Ad Queue, such as daily campaign limit (has the advertiser exceeded their maximum expenditure for the day), relevant ads suited for the channel format, and so on as will be discussed below.

For each term that has a relevance score to a URL, the advertisement selection module 38 may be configured to retrieve all advertisements with active bids of the term in question.

The advertisement selection module 38 may advantageously be configured to use additional criteria to enable it to rank advertisements, for example, in the advertisement queue, in order of their advertisement serving priority. In particular the module 38 is configured to use a value bid by the advertiser for a click or an extrapolated bid per click derived from a cost per mille (CPM) bid to generate the advertisement queue. Instead, or preferably in addition, the advertisement selection module 38 is configured to use information indicative of historic performance of the advertisement-plus-keyword combination to generate the advertisement queue, wherein the performance may be the historic click through rate of the advertisement-plus-keyword combination. The historic performance may be based on the advertisement-plus-keyword, or advertisement-keyword combination, historic performance compared to the system average advertisement-plus-keyword performance.

In other words, the advertisement selection module 38 is configured to assign a ranking score to each item in the advertisement queue, in order to determine the priority of advertisements served to a web page 20. In particular, the ranking score is given as a product of the relevance score stored in the scoring database 44, the bid value as hereinbefore describe, and a quality factor which is associated with the historic performance of the advertisement-plus-keyword combination as hereinbefore described.

It will be noted that the advertisement queue is ordered in descending order from the most relevant advertisement-plus-keyword combination that matched the URL for the relevant location.

The channel setup module 26 may be configured, in response to determining an instance a website or web page 20 comprising the channel setup module 26 is browsed, to generate a frame, for example, an iFrame within the website or web page 20 being browsed for displaying the at least one contextually relevant advertisement. The advertisement served to the module 26 is conveniently served from the advertising server 30. In an example embodiment, the advertisement is displayed by an image tag or JavaScript code inserted by the publisher 12 within their website. The module 26 retrieve or is served the advertisement from the system 12 in real-time.

The advertising server 30 may comprise a registration module 48 configured to receive a registration request from at least the website publisher 14 to register to the online advertising system 12. The registration request typically comprises information indicative of channel format information such as one or more of a size of their advertisement channel, for example, from a pre-determined set of sizes, colours of the channel, format of the advertisements, for example, text only, image only, both text and image ad, or audiovisual advertisements. The registration module 48 may therefore have a website or web front interface (not shown) which website publishers 14 may use to register to the system 12.

It will be noted that advertisers 16 may also register to the system 12 and provide advertisements, with bids on keywords therefor, for serving to the respective website publishers registered to the system 12.

In response to the registration, the advertising server 30 generates or retrieves the channel setup module 26, for example, dynamically; and makes the generated channel setup module available to the website publisher 14 to retrieve and place within their website site or web page. The website publisher 14 typically cuts out the module 26 from the website of the system 12 and simply pastes the module 26 in their website or web page at a position which they desire to have advertisements served.

The advertising server 30 is also configured to determine if a format of a contextually relevant advertisement to be served matches a channel size of the browsed web page 20 to which the advertisement is to be served. The channel size is typically selected as part of the registration as hereinbefore mentioned. In this regard, the server 30 serves or send to the browsed web page 20, only those contextually relevant advertisements which substantially match a channel size of the browsed web page.

It will be appreciated that information relating to advertisement serving history is stored in at least one of the databases of the system 12, even if the advertisement was not clicked. Without this information, an audit history will not be available and no analysis of Click Through Rate (clicks/impressions) can be done, which indicate many factors including:
(a) a good CTR can indicate good relevance of the ad to the webpage and/or good ad creative
(b) a bad CTR can indicate the opposite or (a) above or click fraud—a publisher click on an ad on their own site to earn more revenue or a competing advertiser clicking on a competitors ads to cost them money.
(c) CTR can also be an indicator of overall system health.

In this regard, the information stored, at least for auditing, includes:
DateTime stamp the advertisement was served
DateTime stamp the advertisement was clicked (if it was)
Unique Identifiers that track this particular serving of the ad in order to correlate the click back to it.
advertisement served
URL
Channel ID
Keyword that matched the advertisement
Bid
Actual Cost
Location

It will be noted that the system 12 may be arranged to generate summary data is for each statistical reporting requirement. For example, total clicks & impressions are consolidated for a campaign, advertising groups, then its advertisement-plus-keywords, etc.

The present system 12 allows for bids to be converted to a ‘common denominator’ to ensure that advertisers bidding in different currencies are compared fairly. Also, geo targeting allows an advertiser 16 to target users 22 in a specific location. Note that the location is the origin of the user 22 who views the ad, NOT the location of the website or the location of the advertiser 16. For example, a US advertiser may target South African users. The system 12 may detect that a South African user is browsing a site hosted in the UK, & serve the ad at this point.

The system 12 also has advertisement tracking capabilities, in particular the system 12 is configured to generate a unique URL when an advertisement is delivered that (a) records the click if it takes place & associates it with the particular instance that the advertisement was served, and then (b) redirects the user to the advertisers true destination URL.

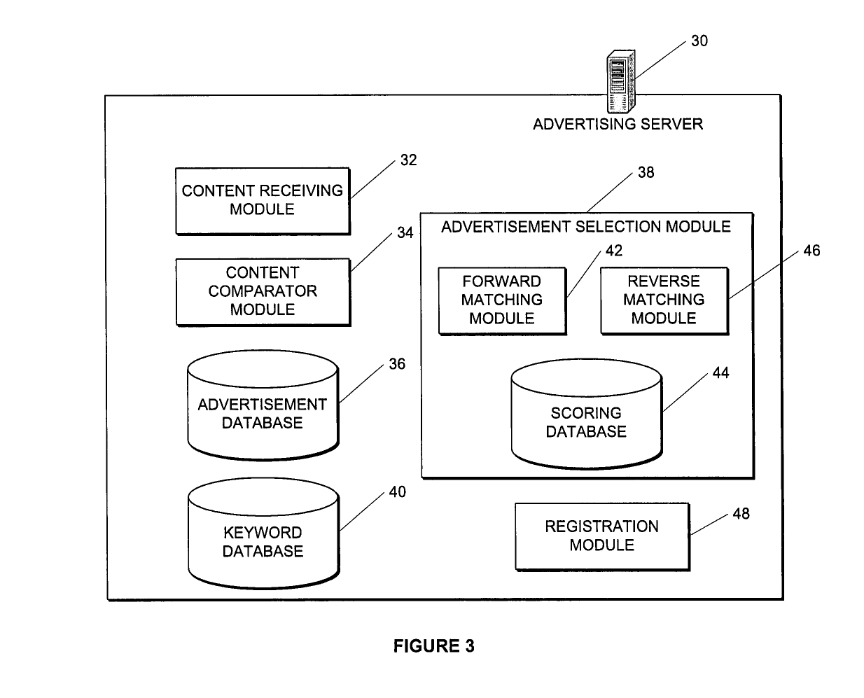

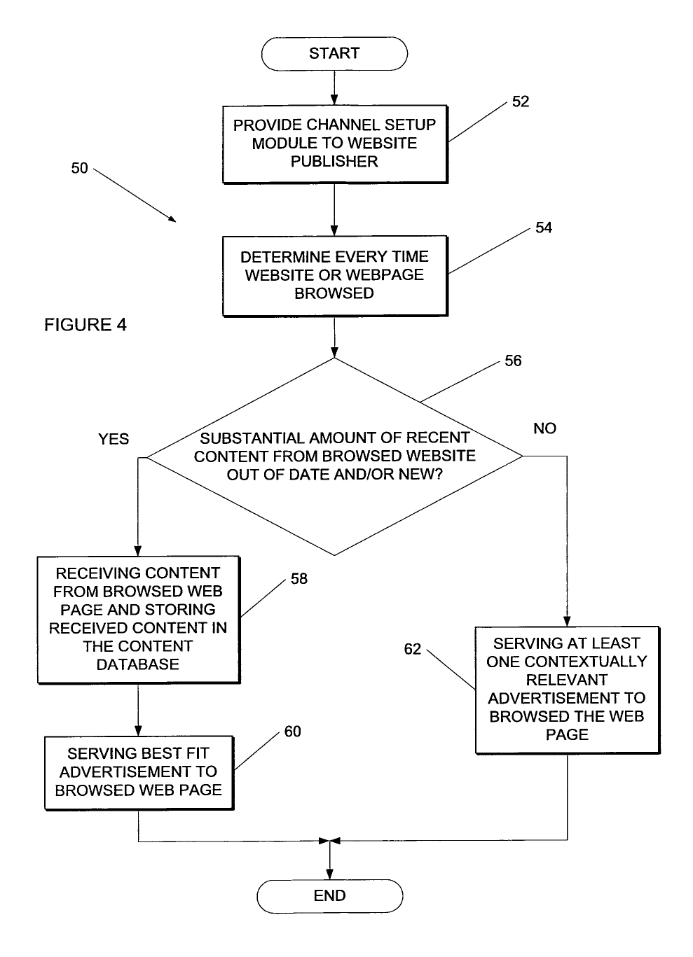

Example embodiments will now be further described in use with reference to FIGS. 4 to 11. The example methods shown in FIGS. 4, 5 and 9 to 7 are described with reference to FIGS. 1 to 3, and 12, although it is to be appreciated that the example methods may be applicable to other systems (not illustrated) as well.

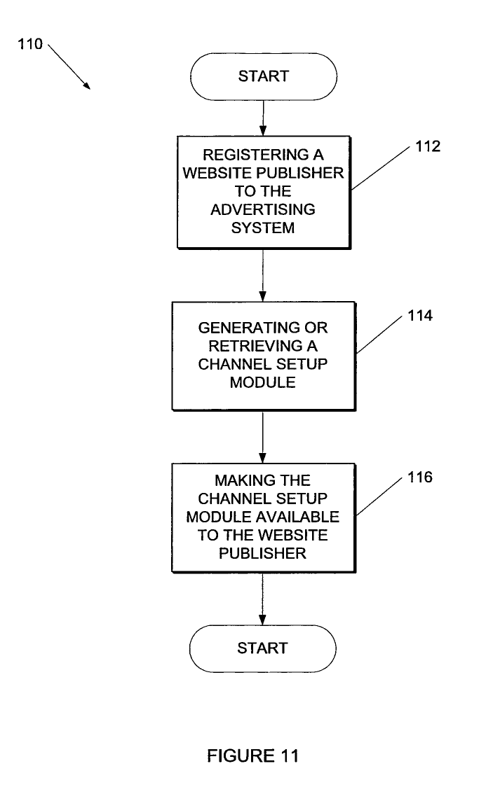

Referring to FIGS. 4 and 11 of the drawings where flow diagrams of methods in accordance with example embodiments are generally indicated by reference numerals 50 and 110 respectively. A website publisher 14 wanting to register to an online advertising system, for example, system 12 typically would typically log onto a website provided by the system 12. The method 110 (FIG. 11) therefore comprises registering, at block 112, a website publisher to the advertising system 12, for example, by way of the registration module 48 as hereinbefore described. It will be appreciated that registering the website publisher 14 may comprise prompting the publisher 14 for information relating to at least the channel or in other words, channel formatting information as hereinbefore described.

The method 110 then comprises generating or retrieving, at block 114, a channel setup module 26 as hereinbefore described typically dynamically after a successful registration. This step is conveniently performed by the system 12.

The method 110 then comprises making the generated or retrieved channel setup module 26 available, at block 116, to the website publisher 14 to retrieve and place within their website site typically in a similar fashion as hereinbefore described.

Turning now to FIG. 4, where it will be noted that step 52 is substantially similar to step 116 of FIG. 11 as hereinbefore described. Once the website publisher 14 has placed the module 26 within a desired location or position within their web page, the method 50 comprises determining, at block 54 by way of the channel setup module 26, every time the web page comprising the channel setup module 26 is browsed. It may be worth reiterating that the module 26 is the key for the system 12 to communicate and interact with a respective web page 20.

Each time a website or web page 20 comprising the channel setup module 26 is browsed, the method 50 comprises determining, at block 56 by way of the advertising server 30, if a substantial amount of recent content or information from the browsed web page 20 is stored in the content database 28, or not.

If a substantial amount of the content from the browsed web page 20 stored in the content database 28 is out of date and/or the browsed web page or a substantial amount of the content associated with the browsed web page 20 is new, the method 50 comprises receiving, at block 58, content from the browsed web page 20 and storing the received content in the content database 28 as hereinbefore described. The method 50 then comprises serving or sending, at block 60, at least one best fit advertisement to the browsed web page 20 as hereinbefore described.

However, if a substantial amount of the content from the browsed web page 20 stored in the content database 28 is not out of date, the method 50 comprises serving or sending, at block 62, at least one selected advertisement to the browsed web page 20 as hereinbefore described.

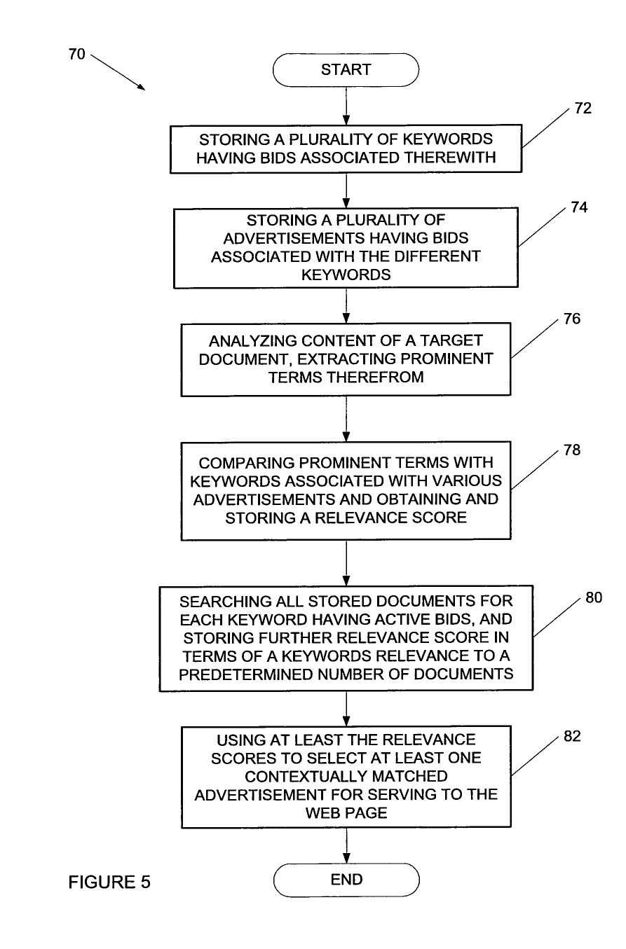

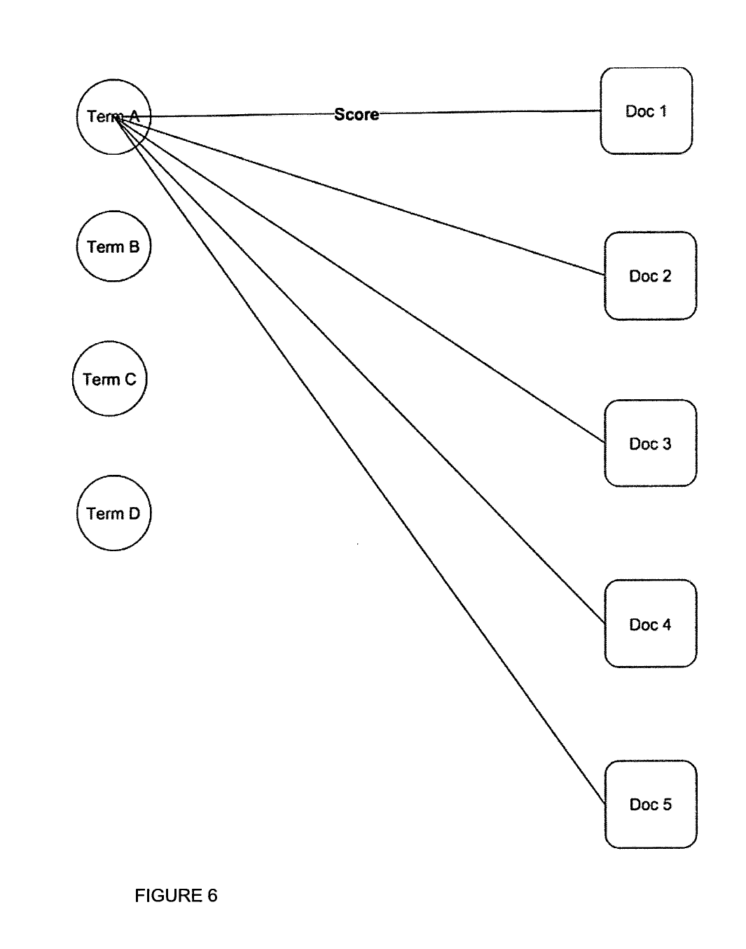

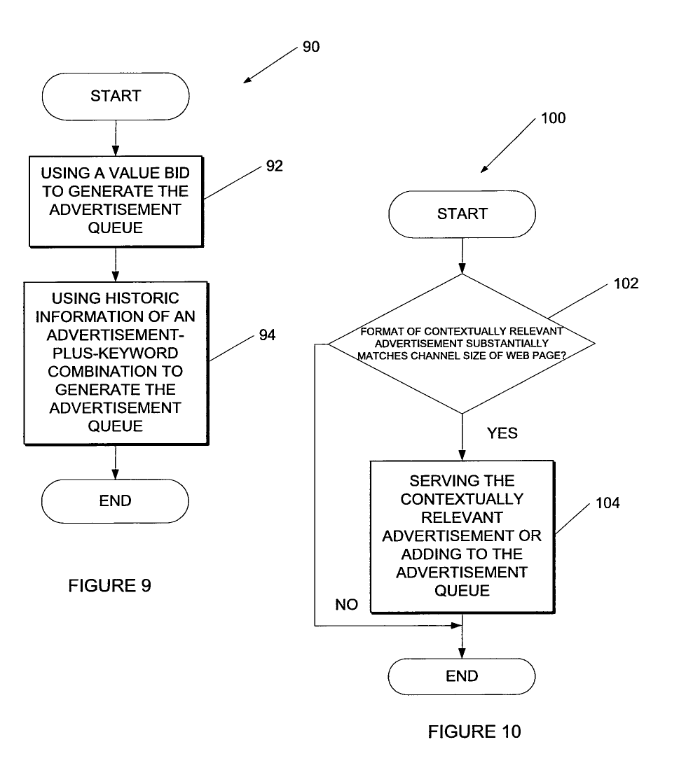

It will be appreciated that in order to serve contextually relevant advertisements, it must be determined which advertisements are contextually relevant to a particular website or web page. In this regard, reference is now made to FIG. 5 of the drawings, where a flow diagram of a method of determining at least one contextually relevant advertisement to be provided to a web page 20 is generally indicated by reference numeral 70. The method 70 will be further explained by FIGS. 6 to 8, and further defined by FIGS. 9 and 10.

The method 70 may advantageously form part of the method 50 of FIG. 4 to enable the system 12 to determine contextually relevant advertisements to serve to a web page 20. However, it will be appreciated that the method 70 may be a standalone method. Similarly, those skilled in the art will understand that those components or modules which lend their functionality to achieve the method 70, although forming part of the system 12, may further form part of a standalone system (not specifically illustrated) to determine contextually relevant advertisements to serve to a web page.

In any event the method 70 comprises, storing, at block 72, a plurality of keywords having bids associated therewith in the keyword database 40.

The method 70 also comprises storing, at block 74, a plurality of advertisements having bids associated with different keywords in the advertisement database 36 as hereinbefore described.

The method 70 comprises analysing, at block 76 by way of the forward matching module 42, content of a target document and extracting prominent terms therefrom as hereinbefore described. It will be appreciated that the method 70 may comprise the prior steps of receiving the target document, or information indicative thereof, for example by way of the module 32 and 26 respectively.

The method 70 then comprises comparing, at block 78, the extracted prominent terms with the keywords associated with various advertisements or advertisement-plus-keyword combinations stored in the advertisement database 36 thereby to obtain and store, in the scoring database 44, a relevance score for each extracted prominent term or keyword associated with the target document. For example, scores of 0 are assigned where there would be no relevance of the term to the document and 1.0 would be a perfect fit. The score of an extracted term from a document reflects what that term would have scored on a search against all stored documents—this score is impacted by the term frequency across the collection of documents. In other words, a term extracted from a document in a collection where the document is the only document within a collection will have a different score to a term extracted from the document when it is part of a collection with many documents. This is illustrated in FIG. 6. Advertisements with bids on the same associated terms or keywords are then correlated to this document as being relevant.

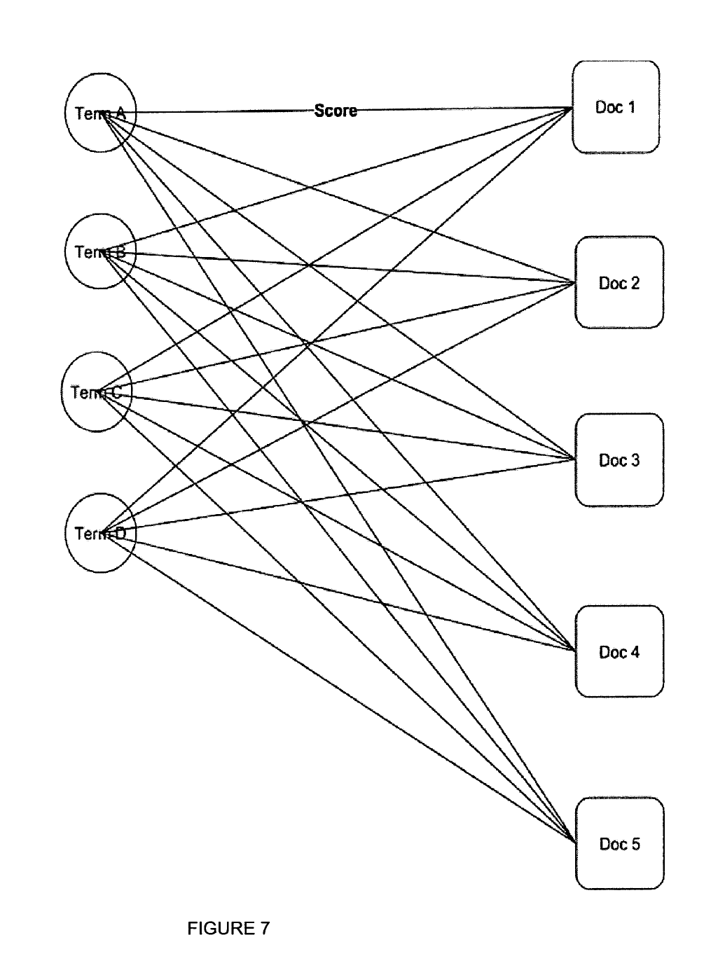

The method 70 then comprises searching, at block 80 by way of the reverse matching module 46, all documents stored in the content database 28, for each identified keyword on which there are active bids, and assigning and storing a further relevance score to each keyword, in the scoring database 44, in terms of a relevance to a predetermined number of relevant documents located in the content database. It will be noted that the entire collection of documents in the content database 28 is searched for each identified term/keyword that has a bid. This is illustrated in FIG. 7. Top documents returned from the search are used to associate any advertisements that bid on the specific term/keyword with each of the documents, along with the relevant score.

The method 70 finally comprises using, at block 82, at least the stored relevance scores to select at least one contextually matched advertisement from the advertisement database 36 for serving or sending to the browsed web page 20.

In particular, the method 70 comprises using at least the stored relevance scores to generate an advertisement queue of contextually matched advertisements in order of priority for serving or sending to the browsed web page 20. It will be appreciated that the forward and reverse processes as described herein are continuously operating so as to continuously update the advertisement queue.

In order to generate the advertisement queue, for each term that has a relevance score to a URL, the system 12 gathers all advertisements with active bids on the term/keyword.

The steps 78 and 80 of the method 70 of FIG. 4 return a set of relevance scores where each score relates to a term/keyword and a document. The next step is to apply the additional criteria that will rank ads in order of ad serving priority. The method 70 therefore extends to building an advertisement queue.

In any event, it will be appreciated that the score of a keyword-advertisement combination will always include the minimum of relevance score and the bid and then possibly the additional criteria. Relevance on its own is not enough to score a keyword-advertisement combination against a target document.

### EXAMPLE

The keyword ‘carpentry’ for advertisement A scores 40% and has a bid of $1 per click against a target document.

The keyword ‘building’ for advertisement B scores 90% and has a bid of $0.20 per click against a target document.

In a simplified form of the algorithm, assuming no other factors are taking into account, the two ads will rank as follows:

| | | | Relevance | | Overall |
|---|---|---|---|---|---|
| Ranking | Ad | Keyword | score | Bid | Score |
| 1 | A | Carpentry | 0.4 | 1.00 | 0.4 |
| 2 | B | Building | 0..9 | 0.20 | 0.18 |

Where:
Overall Score = Relevance Score × Bid

Turning now to FIG. 9 of the drawings where an additional method to method 70 is generally indicated by reference numeral 90. In addition to the relevance scores, the method 90 uses additional criteria in order to build an advertisement queue.

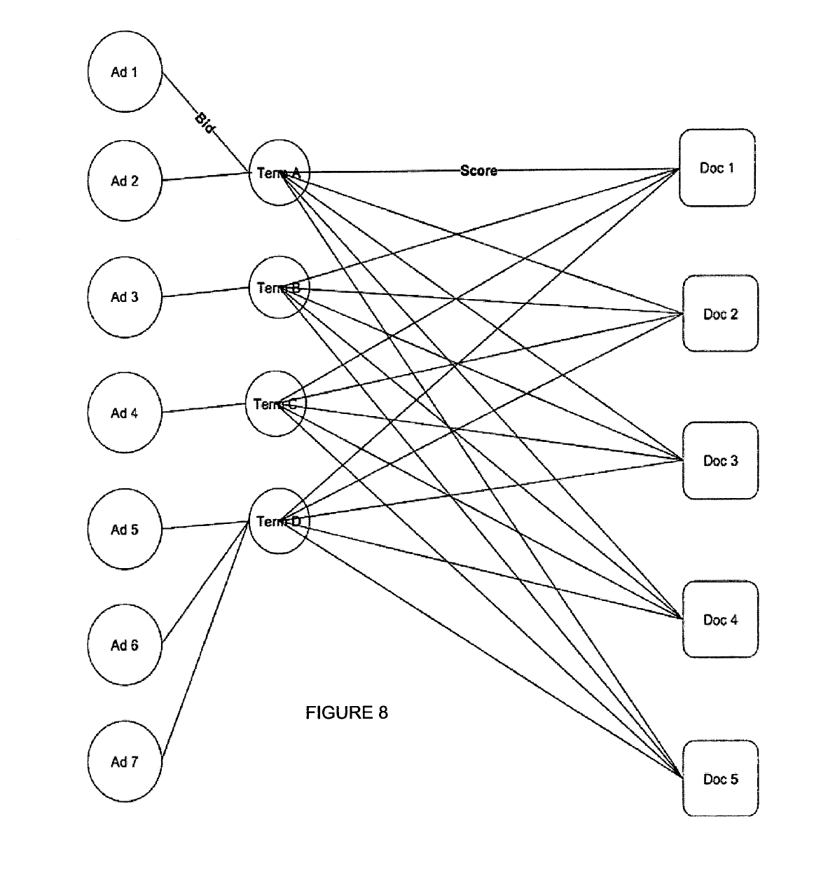

The method 90 comprises, in addition to using the determined relevance scores, using, at block 92, a value bid and also using, at block 94, historic information of an advertisement-plus-keyword combination to generate a ranking score to be used to rank the advertisements in the advertisement queue according to priority, substantially in the same way as hereinbefore described. This is substantially illustrated in FIG. 8.

Additionally, it will be noted that method 100 of FIG. 10 may also be carried out for the advertisements to be placed in the advertisement queue. In particular the method 100 comprises determining, at block 102, if the format of the contextually relevant advertisements located substantially matches the channel format, for example, channel size, of the web page. As hereinbefore described, this channel format information is typically received from the website publisher 14 at registration time. However, this may be edited or varied at any time, for example, by way of the website of the system 12.

The method 100, then comprises serving, at block 104, only those advertisements or placing only those advertisements in the queue which are of substantially the same channel format as the website 20 to which the advertisements are to be served.

Once an advertisement queue is generated it is served to the web page 20 as hereinbefore described. In order to process a request for advertisements from the advertisement database 36 of the system 12, the system 12 requires information indicative of the number of advertisements required, the specific URL of the web page to which the advertisement/s must be served, channel format information (size, text and/image of the advertisement/s) and the geographic location. All this information is typically already stored in one or more databases associated with the system 12. In any event, it will be noted that information indicative of the URL and location will determine the unique advertisement queue that must be queried. Channel format information will be used to retrieve the relevant advertisements whilst the number of advertisements required will be used to determine how many advertisements must be collected (in descending order from the advertisement queue). If a channel is configured for ‘text and image’ format advertisements, an image ad will only appear if it is the first advertisement in the advertisement queue.

When serving the advertisements to a particular “slot” in the web page 20, the higher the variation in advertisements shown to a user 22, the better the performance, hence improved earnings. In this regard, contextually relevant advertisements are served to slots in the following fashion:

| | Matched | |
|---|---|---|
| Ad Queue | Ads | Channel |
| Ad 1 | Ad 1 | Slot 1 |
| Ad 2 | Ad 2 | |
| Ad 3 | Ad 3 | |
| Ad 4 | Ad 4 | |
| Ad 5 | Ad 5 | |
| Ad 6 | Ad 6 | |
| Ad 7 | Ad 7 | |
| Ad 8 | Ad 8 | |
| Ad 9 | Ad 9 | |
| Ad 10 | Ad 10 | |
| Ad 11 | Ad 11 | Slot 2 |
| Ad 12 | Ad 12 | |
| Ad 13 | Ad 13 | |
| Ad 14 | Ad 14 | |
| Ad 15 | Ad 15 | |
| Ad 16 | Ad 16 | |
| Ad 17 | Ad 17 | |
| Ad 18 | Ad 18 | |
| Ad 19 | Ad 19 | |
| Ad 20 | Ad 20 | |
| Ad 21 | | |
| Ad 22 | | |
| Ad 23 | | |

From the contextually relevant advertisement queue of 23 advertisements, advertisements 1 to 10 are selected and are randomly served to the user 22, in Slot 1, during a browsing experience. Similarly, advertisements 11 to 20 are randomly selected and served to the user 22 in slot 2. This approach maximizes the exposure of different contextually relevant advertisements to a user 22 because instead of receiving one relevant advertisement from the queue, the user 22 receives any one of advertisements 1 to 10 in a random fashion.

So even if an advertisement ends up #1 in the queue it may not necessary be served, as the system 12 will select the top X advertisements (for example X=10 in the example above) in the queue and then serve one of them randomly, to increase variance of ads served and thereby ensuring that a user 22 sees more than one advertisement during a web browsing experience.

It will be appreciated that methods described herein may be computer implemented methods and the present invention therefore also extends to a set of computer executable instructions storable in a suitable storage device, which instructions when executed by a machine, for example a computer, causes the machine to perform the any of the method steps as described herein.

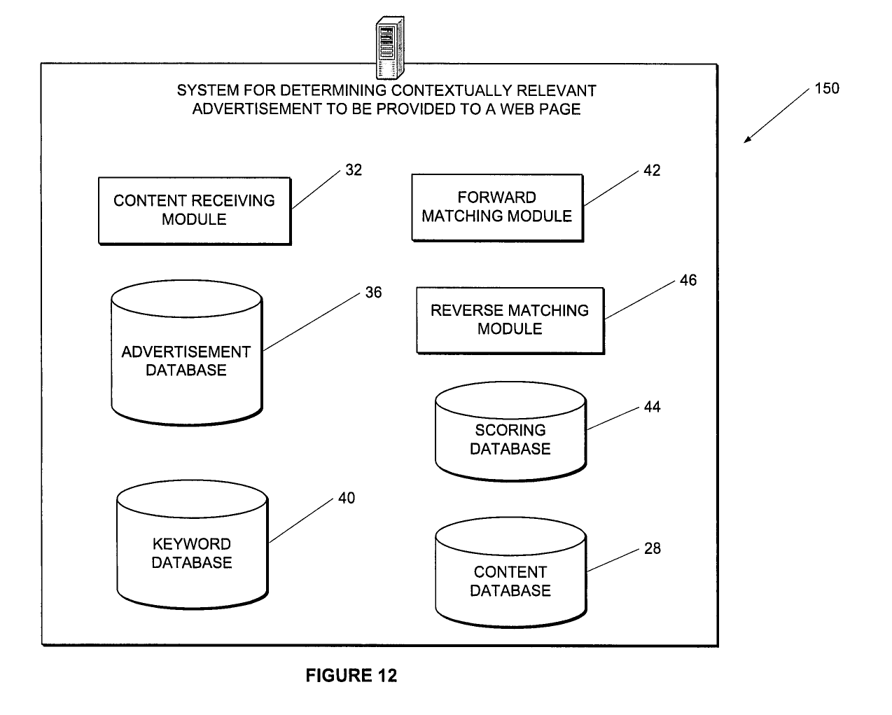

Turning now to FIG. 12 of the drawings where a system for determining at least one contextually relevant advertisement to be provided to a web page, for example, web page 20 is generally indicated by reference numeral 150. Although the system 150 may comprise similar elements to the advertising server 30, the system 150 may be a standalone system communicating with advertising system 12, or any other system, and is therefore illustrated as such.

System 150 comprises similar components or modules as the server 30 as hereinbefore described and in this regard, same reference numeral will be used to indicate like components or modules. In particular, the system 150 comprises databases 28, 36, 40, and 44 as well as modules 42, 46, and 32 which operate in a similar manner as hereinbefore described to determine at least one contextually relevant advertisement to be provided to the web page 20. The system 150 may serve the advertisements to the web site directly, for example, via the module 26 as described above or may merely select the advertisements which the website publisher would include in their respective website.

It will be understood that the example methods hereinbefore described with reference, in particular, to FIGS. 5 to 10, may substantially be applicable to system 150.

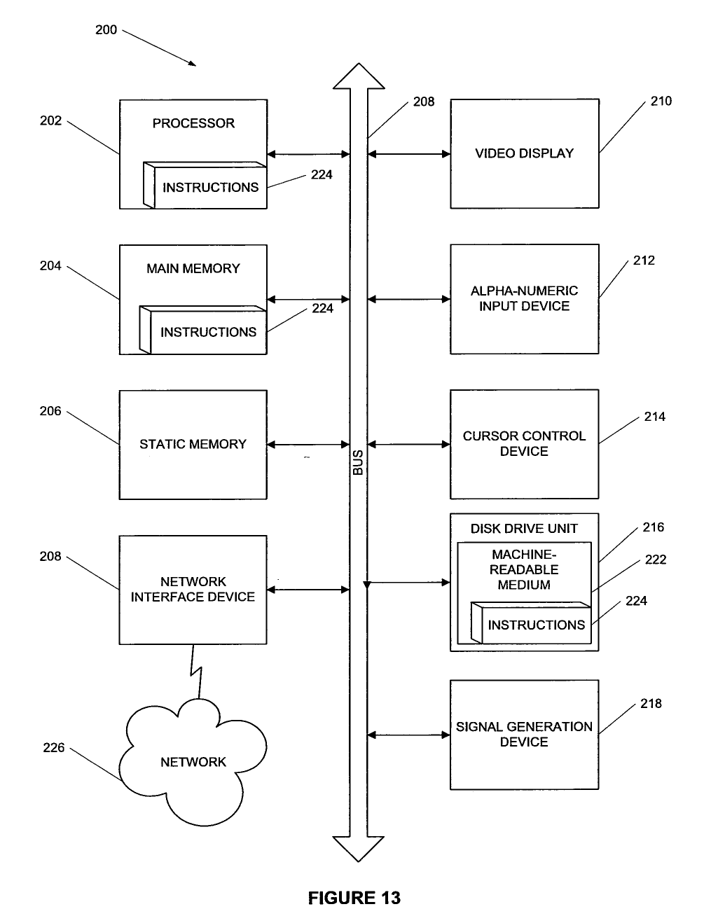

FIG. 13 shows a diagrammatic representation of machine in the example form of a computer system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU), a graphics processing unit (GPU) or both), a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220 utilizing any one of a number of well-known transfer protocols (e.g., HTTP).

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The present invention provides a method and system to provide contextually relevant advertisements to web pages or websites. The invention also provides an online advertising method and/or system which maximizes performance of online advertisement campaigns, handles large volumes of website publishers, online advertisers and hence advertisements, can be scaled to growth needs, and be highly resilient. The invention also maximizes the potential for website publishers to increase revenue based on the contextually relevant advertisements. The present invention advantageously establishes contextual relevance in two different ways and then applies additional factors to insert the advertisement into the queue. As described above, these additional factors are the value of the bid as well as the historic ad quality (based on its past performance for this specific term). So the order in the advertisement queue does not only depend on the relevance. Also, because the system as hereinbefore described selects the top X advertisements in a queue and then serves one of them randomly, the user is exposed to more than one advertisement during a web browsing experience thereby maximizing advertising exposure.

1. A method for determining at least one contextually relevant advertisement to be provided to a web page, the method comprising:
storing a plurality of keywords having bids associated therewith in a keyword database;
storing a plurality of advertisements having bids associated with different keywords in an advertisement database;
analyzing content of a target document and extracting prominent terms therefrom, wherein the target document is associated with content of a particular web page referenced by a particular URL;
comparing the extracted prominent terms with the keywords associated with various advertisements or advertisement-plus-keyword combinations stored in the advertisement database thereby to obtain and store, in a scoring database, a relevance score for each extracted prominent term or keyword associated with the target document;
searching all documents stored in the content database, for each keyword on which there are active bids, and assigning and storing a further relevance score to each keyword, in the scoring database, in terms of a relevance to a predetermined number of relevant documents located in the content database; and
using at least the stored relevance scores to select at least one contextually matched advertisement from the advertisement database for serving or sending to the browsed web page.

2. The method as claimed in claim 1, the method comprising using at least the stored relevance scores to generate an advertisement queue of contextually matched advertisements in order of priority for serving or sending to the browsed web page.

3. The method as claimed in claim 2, the method comprising using information indicative of historic performance of the advertisement-plus-keyword combination to generate the advertisement queue, wherein the performance comprises the historic click through rate of the advertisement-plus-keyword combination.

4. The method claimed in claim 2, the method comprising generating the advertisement queue by using one or more of a value bid by an advertiser for a click and an extrapolated bid per click derived from a cost per mille (CPM).

5. The method as claimed in claim 1, the method comprising:
determining if a format of a contextually relevant advertisement to be served matches a channel format, or the channel size, of the browsed web page to which the advertisement is to be served; and
serving or sending to the browsed web site only those contextually relevant advertisements which substantially match a channel format size of the browsed web page.

6. The method as claimed in claim 1, wherein the method comprises the step of receiving the target document to be analysed.

7. The method as claimed in claim 6, wherein the method comprises the step of receiving the target document to be analysed by way of a channel setup module disposed in the web page.

8. The method as claimed in claim 1, the method comprising serving or sending the at least one contextually matched advertisement to the web page.

9. The method as claimed in claim 1, wherein the prominent terms are the most frequently occurring terms in the target document.

10. The method as claimed in claim 1, wherein for each term that has a relevance score to a URL, the method comprises retrieving all advertisements with active bids on the term in question.

11. The method as claimed in claim 1, wherein the score of a term from a particular document is affected by the frequency of the term within the document and also with the frequency of the term in an entire collection of documents in the content database.

12. A system for determining at least one contextually relevant advertisement to be provided to a web page, the system comprising:
a keyword database configured to store at least a plurality of keywords having bids associated therewith;
an advertisement database configured to store at least a plurality of advertisements having bids associated with different keywords;
a forward matching module configured to:
analyze content of a target document and extracting prominent terms therefrom, wherein the target document is associated with content of a particular web page referenced by a particular URL;
compare the extracted prominent terms with the keywords associated with various advertisements or advertisement-plus-keyword combinations stored in the advertisement database thereby to obtain and store, in a scoring database, a relevance score for each extracted prominent term or keyword associated with the target document;
and
a reverse matching module configured to search all documents stored in the content database, for each keyword on which there are active bids, and assign and store a further relevance score to each keyword, in the scoring database, in terms of a relevance to a predetermined number of relevant documents located in the content database;
wherein the system is configured to use at least the stored relevance scores to select at least one contextually matched advertisement from the advertisement database for serving or sending to the browsed web page.

13. The system as claimed in claim 11, wherein the system is configured to use at least the stored relevance scores to generate an advertisement queue of contextually matched advertisements in order of priority for serving or sending to the browsed web page.

14. The system as claimed in claim 13, wherein the system is configured to use information indicative of historic performance of the advertisement-plus-keyword combination to generate the advertisement queue, wherein the performance comprises the historic click through rate of the advertisement-plus-keyword combination.

15. The system as claimed in claim 13, wherein the system is configured to generate the advertisement queue by using one or more of a value bid by an advertiser for a click and an extrapolated bid per click derived from a cost per mille (CPM).

16. The system as claimed in claim 12, the system comprising:
means for determining if a format of a contextually relevant advertisement to be served matches a channel format, or the channel size, of the browsed web page to which the advertisement is to be served; and
means for serving or sending to the browsed web site only those contextually relevant advertisements which substantially match a channel format size of the browsed web page.

17. The system as claimed in claim 12, wherein the forward matching module is configured to receive the target document to be analysed by way of a content receiving module communicatively coupled to a channel setup module disposed in the web page.

18. The system as claimed in claim 12, the system comprising means to serve or send the at least one contextually matched advertisement to the web page.

19. The system as claimed in claim 12, wherein the prominent terms are the most frequently occurring terms in the target document.

20. The system as claimed in claim 12, wherein the system is included in an advertising server.
